(19) United States
(12) Patent Application Publication
(10) Pub. No.: US 2006/0225959 A1
(43) Pub. Date: Oct. 12, 2006

(54) Paint tray

(76) Inventor: Norman R. Pohl, Ancaster (CA)

Correspondence Address: GOWLING, LAFLEUR HENDERSON LLP, ONE MAIN STREET WEST, HAMILTON, ON, L8P 4Z5, CA

(21) Appl. No.: 11/235,133

(22) Filed: Sep. 27, 2005

Related U.S. Application Data
(60) Provisional application No. 60/668,592, filed on Apr. 6, 2005.

(51) Int. Cl. E06C 5/32

(52) U.S. Cl. 182/129

(57) ABSTRACT

A paint tray has side walls with hook-shaped extensions which are engageable with a rung of a ladder to enable the paint tray to be hung therefrom. The side walls also have wall-like extensions adjacent the opposite end. The base has an extension extending between the wall-like extensions and having a reversely bent portion to form a paint reservoir when the paint tray is upright. The wall-like extensions have hook-shaped portions adjacent the upper front edge of the paint reservoir which are engageable with a rung of a ladder with the paint reservoir behind the rung when the hook-shaped extensions are engaged with a higher rung.

### RELATED APPLICATION

This invention claims priority from U.S. Provisional Patent Application No. 60/668,592 filed Apr. 6, 2005.

### FIELD OF INVENTION

This invention relates to paint trays.

### BACKGROUND OF INVENTION

It is very easy to spill paint from a conventional paint tray when moving it from one place to another. Also, it is very difficult to use a conventional paint tray when painting a surface which requires the use of a ladder. A multi-positioned paint tray has been disclosed in U.S. Pat. No. 6,622,340 (Rosa), but the paint tray disclosed is difficult and awkward to use.

It is therefore an object of this invention to provide an improved paint tray from which spilling is less likely and which can be easily used when the painter is on a ladder.

### SUMMARY OF INVENTION

According to the invention, a paint tray has a substantially planar base over which a paint roller can be rolled and a pair of sidewalls on opposite sides of the base. The sidewalls have hook-shaped extensions adjacent one end which are capable of engagement with a rung of a ladder to enable the paint tray to be hung therefrom. The sidewalls also have wall-like extensions adjacent the opposite end, the base having an extension extending between the wall-like extensions and having a reversely bent portion to form a paint reservoir when the paint tray is oriented with the planar base in a substantially upright position. The wall-like extensions have hook-shaped portions adjacent the upper front edge of the reservoir which are engageable with a rung of a ladder with the paint reservoir behind the rung when the hook-shaped extensions are engaged with a higher rung. The hook-shaped extensions and the wall-like extensions are operable to function as supports when the tray is located on a substantially horizontal surface with the planar base substantially level.

The wall-like extensions may also be operable to function as supports when the tray is located on a substantially horizontal surface and the planar base is substantially upright.

The tray may have an upper transverse wall extending across the base at said one end, the upper transverse wall having a notch to receive a portion of a paint roller to enable the paint roller to be mounted on the paint tray with a roller member of the paint tray engaging the base between the side walls.

### DESCRIPTION OF THE DRAWINGS

Embodiments of the invention will now be described, by way of example, with reference to the accompanying drawings, of which:

FIG. 1 is a perspective view of a paint tray in accordance with one embodiment of the invention and with its planar base in a substantially level (but slightly inclined) orientation,

FIG. 2 is a pictorial view showing the paint tray and an attached paint roller being carried,

FIG. 3 is a perspective view showing the paint tray (with attached paint roller) mounted on a ladder with the planar base in a substantially upright orientation, and

FIG. 4 is a similar view showing the paint roller being used by a painter standing on the ladder.

### DESCRIPTION OF PREFERRED EMBODIMENT

Referring to the drawings, a paint tray formed from plastic material has a substantially planar base 10 over which a paint roller 12 can be roiled and a pair of side walls 14, 16 on opposite sides of the base 10. The side walls 14, 16 have hook-shaped extensions 18, 20 adjacent one end and have wall-like extensions 22, 24 adjacent the opposite end. The base 10 has an extension 26 extending between the wall-like extensions 22, 24 and having a reversely bent portion 28 to form a paint reservoir 30.

The planar base 10 has an end wall 32 adjacent the hook-shaped extensions 18, 20 and having a carrying handle 34. The wall-like extensions 22, 24 have hook-shaped portions 36, 38 adjacent the upper front edge of the reservoir 30, and the reversely bent portion 28 has an end portion 39 extending between the hook-shaped portions 36, 38.

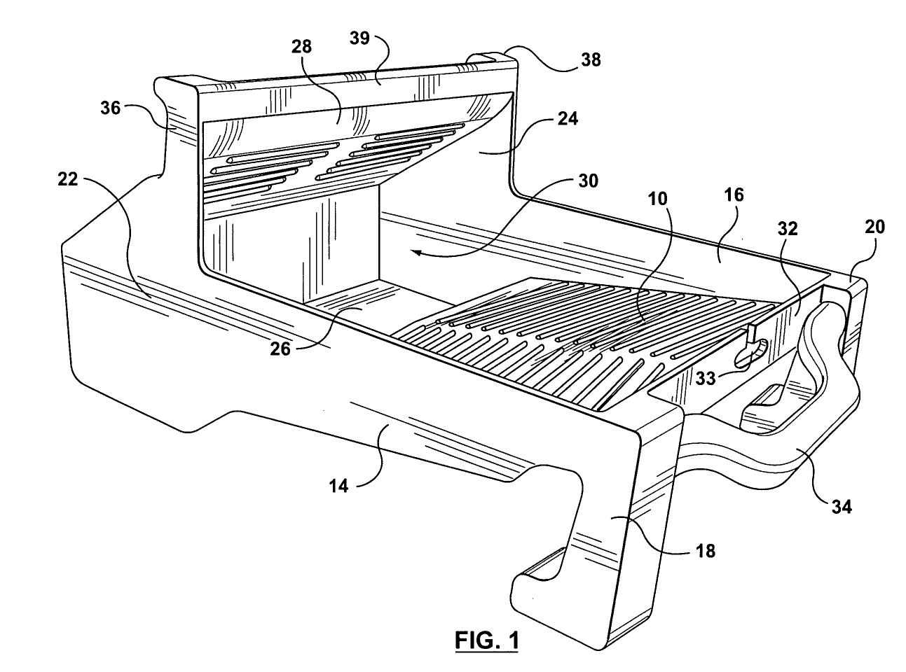

FIG. 1 shows the paint tray in an orientation with the planar base 10 substantially level, but with the planar base 10 inclined downwardly towards the reservoir 30. The base 10 is supported in this position by the hook-shaped portions 18, 20 and the wall-like extensions 22, 24. The paint tray can be used like a conventional paint tray, i.e. with paint in the reservoir 30 and the planar base 12 used to roll a paint roller thereon.

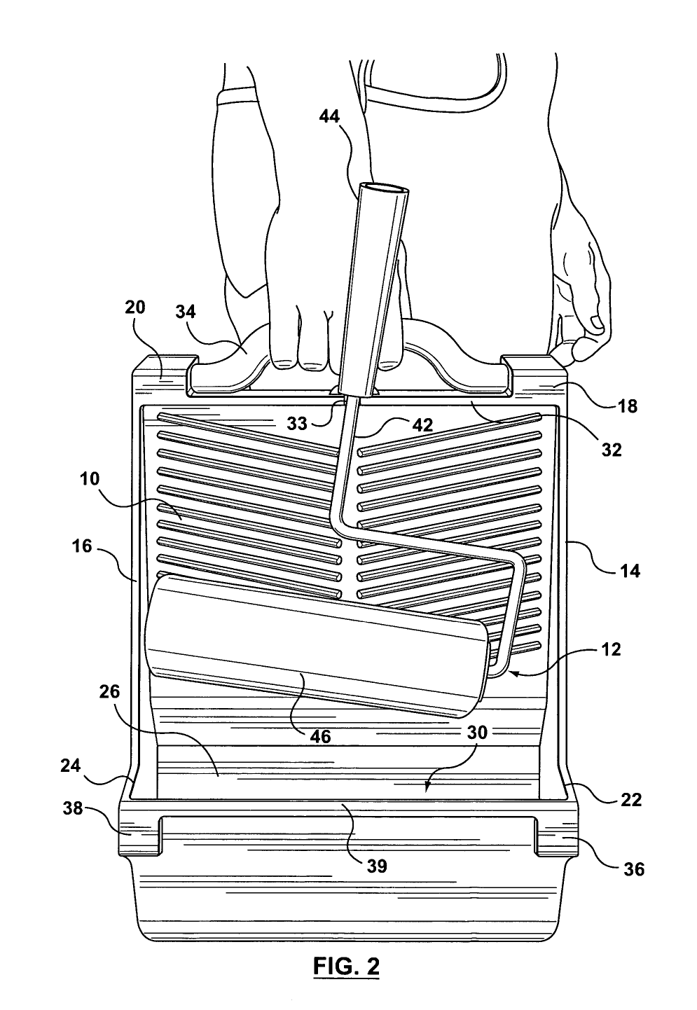

When it is desired to move the paint tray from one location to another, a painter can grip the carrying handle 34 (as shown in FIG. 2) to carry the paint tray with the base 12 in a substantially upright orientation and with the reservoir 30 functioning in a bucket-like manner. It will be readily understood that the likelihood of spilling paint from the reservoir 30 when the paint tray is in this orientation is minimal. It will also be noted that, in this orientation, the paint tray can be placed on a horizontal surface with the wall-like extensions 22, 24 with the bottom of the reservoir 30 maintaining the tray in this orientation.

The end wall 32 has a slot 33 in which the paint roller 12 can be mounted, as shown in FIG. 2, with the portion of the roller frame 42 just below the handle 44 being located in the slot 33 so that the roller member 36 is adjacent the base 10 just above the reservoir 30.

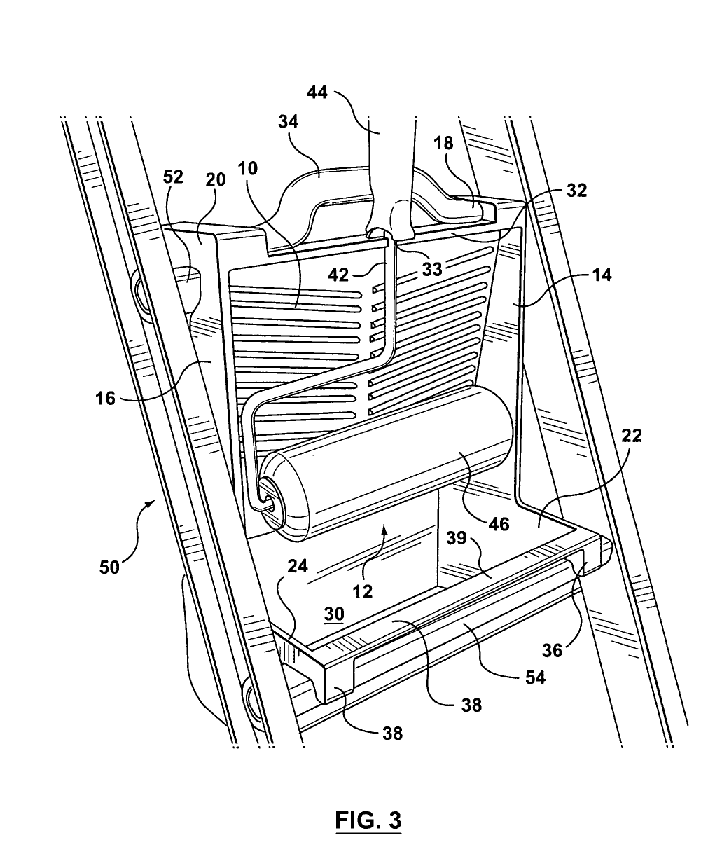

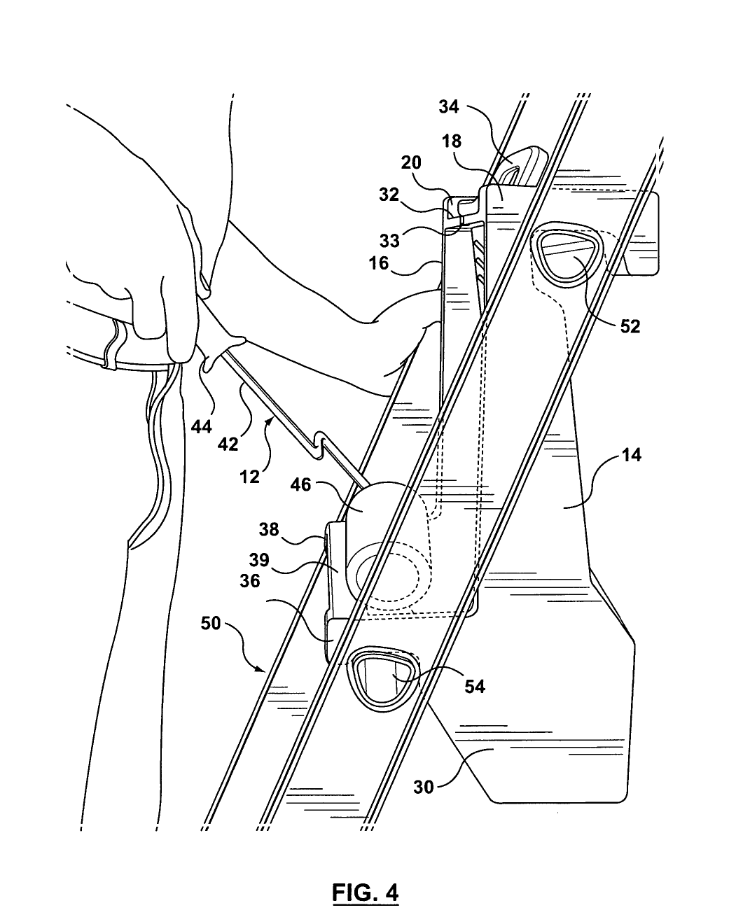

FIG. 3 illustrates the tray mounted on a ladder 50. The hook-shaped extensions 18, 20 can be engaged with an upper rung 52 of a ladder 50 and a hook-shaped portions 36, 38 can be engaged with a lower rung 54. In this position, a painter on the ladder can use the paint tray in a normal manner, as shown in FIG. 4. As again will be readily apparent, likelihood of paint being spilled from the reservoir 30 is minimal. It will also be noted that most of the paint tray, including the reservoir 30, is located behind the ladder 50, i.e. does not project from the front of the ladder to cause an obstacle which might interfere with the work of the painter.

Other advantages and embodiments of the invention will now be readily apparent to a person skilled in the art from the foregoing description.

1. A paint tray having:
a substantially planar base over which a paint roller can be rolled and a pair of side walls on opposite sides of the base,
the side walls having hook-shaped extensions adjacent one end which are engageable with a rung of a ladder to enable the paint tray to be hung therefrom,
the side walls also having wall-like extensions adjacent the opposite end, and the base having an extension extending between the wall-like extensions and having a reversely bent portion to form a paint reservoir when the paint tray is oriented with the planar base in a substantially upright position,
the wall-like extensions having hook-shaped portions adjacent the upper front edge of the paint reservoir which are engageable with a rung of a ladder with the paint reservoir behind the rung when the hook-shaped extensions are engaged with a higher rung, and
the hook-like extensions at said one end and the wall-like extensions at said opposite end being operable to function as supports when the tray is located on a substantially horizontal surface with the planar base in a substantially level position.

2. A paint tray according to claim 1 wherein the wall-like extensions are also operable to function as supports when the tray is located on a substantially horizontal surface with the planar base in a substantially upright position.

3. A paint tray according to claim 1 wherein an upper transverse wall extends across the base at said one end, the upper transverse wall having a notch to receive a portion of a paint roller to enable the paint roller to be mounted on the paint tray with a roller member of the paint tray engaging the base between the side walls.
